(19) United States
(12) Patent Application Publication
(10) Pub. No.: US 2007/0162261 A1
(43) Pub. Date: Jul. 12, 2007

(54) METHOD AND ARRANGEMENT FOR PROCESSING DATA

(75) Inventors: Joakim Notstrand, Linkoping (SE); Ulf Samuelsson, Linkoping (SE); Leif Axelsson, Linkoping (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: SAAB AB, Linkoping (SE)

(21) Appl. No.: 11/537,661

(22) Filed: Oct. 2, 2006

(30) Foreign Application Priority Data
Oct. 7, 2005 (EP) 05109355.7

(51) Int. Cl. G06F 17/00

(52) U.S. Cl. 702/189; 702/127

(57) ABSTRACT

Present invention relates to an arrangement, suitable for increasing data association accuracy, comprising means for generating a first data entity comprising a first information set and a second information set about at least one object; and means for generating a second data entity comprising a first information set and second information set about at least one object. The invention is characterized by means for generating at least one distance matrix depending upon the first information sets or the second information sets; means for gating said at least one generated distance matrix, and means for performing an association process depending upon the gated distance matrix.

### FIELD OF THE INVENTION

The invention relates in general to an arrangement or system for improving data association accuracy, wherein the data is generated by different sensors onboard a platform.

The invention also relates to a method for improving data association accuracy.

Furthermore, the invention relates to software adapted to perform a method for improving data association accuracy when executed on a computer.

### BACKGROUND OF THE INVENTION

Today, platforms such as airplanes, helicopters and unpiloted aircraft are provided with a number of different sensors each having unique characteristics.

A radar unit provided on a platform is arranged to measure a distance between an object and the platform with a relatively high accuracy; the object is typically another platform such as an airplane. The radar unit is also arranged to measure a solid angle to the object relative to the platform with a relatively high accuracy. Furthermore, modern radar units are arranged to generate identity data comprising information about the detected object, in particular the type of platform, e.g. type of airplane. One way to perform this is to detect motor tones of the object so as to match the tones with data stored in a database, hopefully resulting in an identification of the object.

Contemporary platforms are often also provided with a radar warning unit. A distance from the platform to the object can only be measured with inexactitude by means of the radar warning unit. The same applies to measurements of a solid angle to the object relative to the platform. Furthermore, radar warning systems are arranged to identify the sending radar's transmitter type by performing a matching procedure in compliance with the above.

By virtue of the fact that platforms are provided with different sensors which measure different characteristics with varying confidence, associations of measured data representing different objects involve erroneous matching and fusion. This may have disastrous consequences within the avionic field if, for example, a faulty picture of a surrounding of a platform is presented for the pilot of the platform or a control tower on the ground.

### SUMMARY

One object of the invention is to improve association confidence of data representing at least one object provided in the surroundings of a platform.

Another object of the invention is to improve association of data representing objects provided in the surroundings of a platform, wherein the data is generated by different sensors onboard the platform.

Yet another object of the invention is to facilitate association of objects detected by a radar unit and a radar warning unit, respectively.

Yet another object of the invention is to provide a more robust data association process and potentially a faster calculation process.

These and other objects are achieved by an arrangement, suitable for increasing data association accuracy, comprising

means for generating a first data entity comprising a first information set and a second information set about at least one object; and

means for generating a second data entity comprising a first information set and second information set about at least one object,

characterized by

means for generating at least one distance matrix depending upon the first information sets or the second information sets;

means for gating said at least one generated distance matrix, and

means for performing an association process depending upon the gated distance matrix.

Preferably the arrangement comprises:

means for generating a combined distance matrix based upon the at least one gated distance matrix.

Preferably the arrangement comprises:

means for generating a first distance matrix comprising the first information sets; and

means for generating a second distance matrix comprising the second information sets.

Preferably the arrangement comprises:

means for performing the association process depending upon the generated combined distance matrix or the generated distance matrixes.

Preferably the arrangement comprises:

one of the first information set or the second information set comprises kinematics data about the at least one object.

Preferably the arrangement comprises:

one of the first information set or the second information set comprises identity data about the at least one object.

Preferably the arrangement comprises:

means for gating the generated distance matrixes separately.

The invention also relates to a platform, such as an airplane, helicopter or unmanned craft, comprising an arrangement as depicted above.

Advantageously the arrangement provides a more reliable association process because of the separate gating of at least one setup of kinematics data entities or identity data entities. This provides the positive effect of avoiding erroneous association of rather simple cases where association architectures according to prior art result in faulty associations.

By using separate gating of at least one setup of kinematics data entities or identity data entities the association process requires less computational time, while the gating already has reduced the number of possible association combinations.

A surprising benefit of the separate gating processes is that improved target data information is provided to an operator of the platform, which in military applications could be vital.

The method according to the invention is particularly advantageous if a large number of objects are detected by the sensors. Since large distance matrixes imply heavy calculation loads the separated gating processes provides a great reduction of elements to be associated.

Further, the method and arrangement according to the invention provides prerequisites for autonomity for unmanned platforms, because more reliable data is necessary in case an operator is not provided to make decisions.

Additional objects, advantages and novel features of the present invention will become apparent to those skilled in the art from the following details, as well as by practice of the invention. While the invention is described below, it should be understood that the invention is not limited to the specific details disclosed. A person skilled in the art having access to the teachings herein will recognise additional applications, modifications and embodiments in other fields, which are within the scope of the invention.

### BRIEF DESCRIPTION OF THE DRAWINGS

For a more complete understanding of the present invention and further objects and advantages thereof, reference is now made to the following description of examples—as shown in the accompanying drawings, in which:

FIG. 1 schematically illustrates a platform 100, according to an embodiment of the invention.

FIG. 2 schematically illustrates an association architecture, according to a first embodiment of the invention.

FIG. 3a schematically illustrates an association architecture, according to a second embodiment of the invention.

FIG. 3b schematically illustrates an association architecture, according to a third embodiment of the invention.

FIG. 4a schematically illustrates a matrix comprising data, according to an aspect of the invention.

FIG. 4b schematically illustrates a matrix comprising data, according to an aspect of the invention.

FIG. 4c schematically illustrates a matrix comprising data, according to an aspect of the invention.

FIG. 5a schematically illustrates a method for associating data, according to an aspect of the invention.

FIG. 5b schematically illustrates a method for associating data in greater detail, according to an aspect of the invention.

FIG. 5c schematically illustrates a method for associating data, according to an aspect of the invention.

FIG. 6 schematically illustrates an apparatus according to an aspect of present invention.

### DETAILED DESCRIPTION OF THE DRAWINGS

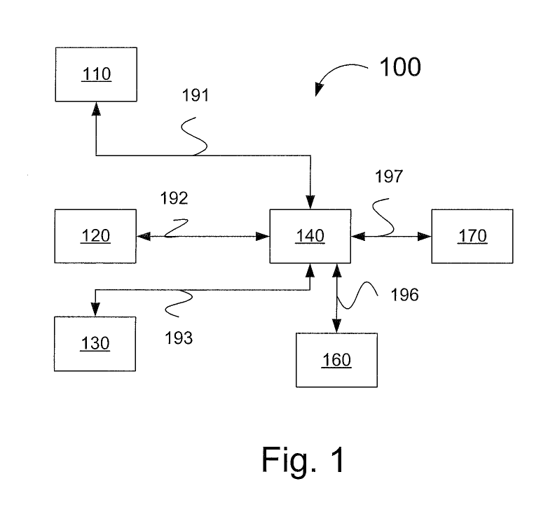

FIG. 1 schematically illustrates components housed in a platform 100, such as an airplane, Unmanned Aerial Vehicle (UAV), or helicopter. Alternatively, the platform can be a watercraft, such as a motor boat, or a ground vehicle, e.g. an automobile.

The platform 100 comprises a control unit 140 arranged for communication with a first sensor 110 via a first data link 191. The control unit is also arranged for communication with a second sensor 120 via a second data link 192. The control unit is also arranged for communication with a third sensor 130 via a third data link 193. The control unit 140 is arranged to control the first, second and third sensors 110, 120, 130.

The first sensor 110 is a radar unit, also referred to as RR, arranged to communicate detected data to the control unit 140. The second sensor 120 is a radar warning receiver, also referred to as RWR, arranged to communicate detected data to the control unit 140. The third sensor 130 is an infrared (IR) camera arranged to communicate image data or film sequence data to the control unit 140. Other additional sensor units can be used and the invention is not limited to the three different sensors depicted herein. Alternatively, the third sensor can be, for example, a laser device adapted for measuring a distance to an object from the platform 100. Alternatively, the third sensor can be a light detection device or a sound detection device.

The object can be another platform, such as an airplane, UAV or helicopter. The object can also be a missile, robot or grenade.

It should be noted that an arbitrary number of different sensors can be used in pairs or in combination according to the invention.

The control unit 140 is arranged for communication with a database 170 via a data base link 197. The control unit 140 is arranged for communication with an I/O-unit 160 via an I/O link 196. In an alternative setup the control unit 140 comprises the database 170.

The database 170 is arranged to store a library comprising profiles of a variety of different platforms. The profiles comprise information about characteristics of the different platforms, e.g. engine type, radar type and corresponding features, such as number of rotors in the engine. The control unit 140 is arranged to perform matching procedures between data generated by any of the first, second and/or third sensor and profile data pre-stored in the database 170 so as to identify the type and status of an object represented by the generated data.

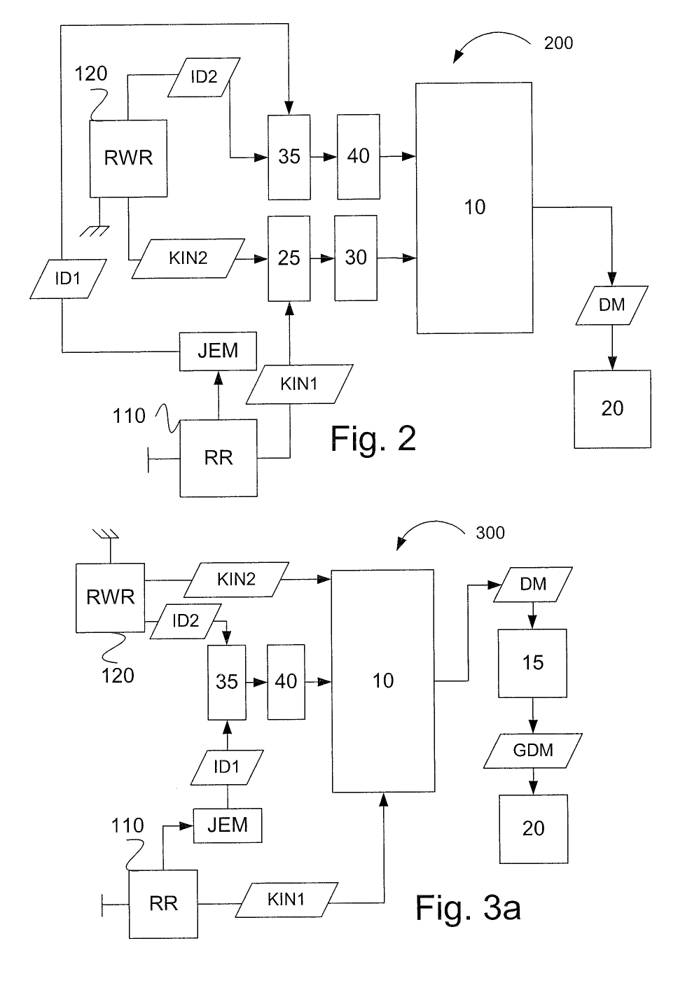

FIG. 2 schematically illustrates an association architecture 200 according to an embodiment of the invention, wherein the radar sensor 110 is arranged to generate a first kinematics data entity KIN1 and a first identity data entity ID1. The radar sensor 110 is provided with a jet engine modulator JEM being arranged to generate a part of the first identity data entity ID1. For purposes of illustration the JEM is shown separately from the radar unit 110 (RR). The first kinematics data entity KIN1 and a first identity data entity ID1 are described in further detail hereinafter.

The radar warning sensor 120 (RWR) is arranged to generate a second kinematics data entity KIN2 and a second identity data entity ID2. The second kinematics data entity KIN2 and the second identity data entity ID2 are described in further detail hereinafter.

An identity distance matrix generating process 35 is applied to generate an identity distance matrix IDM comprising the first and second identity data entities ID1 and ID2.

A kinematics distance matrix generating process 25 is applied to generate a kinematics distance matrix KINM comprising the first and second kinematics data entities KIN1 and KIN2.

Subsequently, an identity data gate 40 and a kinematics data gate 30 are applied to the generated identity distance matrix IDM and the kinematics distance matrix KINM, respectively, according to the structure shown in FIG. 2.

The gated identity distance matrix GIDM and the gated kinematics distance matrix GKINM are then processed in a distance matrix generating process 10 which is adapted to generate a combined distance matrix DM comprising elements of combined data achieved from the gates 30 and 40. According to one embodiment the gated kinematics distance matrix GKINM and the gated identity distance matrix GIDM are added so as to result in the distance matrix DM.

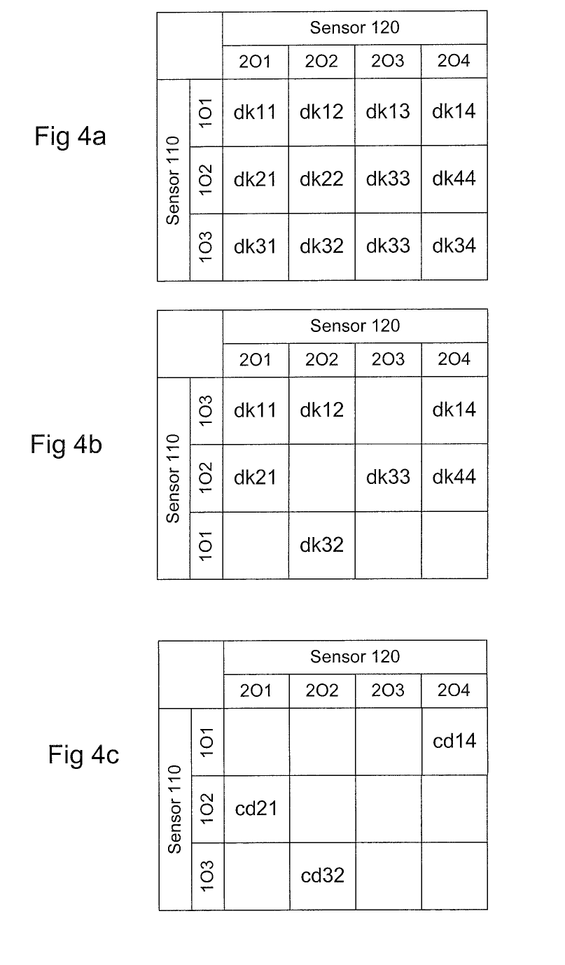

In a process step 20 the generated distance matrix DM is subjected to an association procedure. The result of subjecting the distance matrix DM to the association procedure is a final match between objects detected by the sensors 110 and 120. This is illustrated in greater detail with reference to FIGS. 4a-4c.

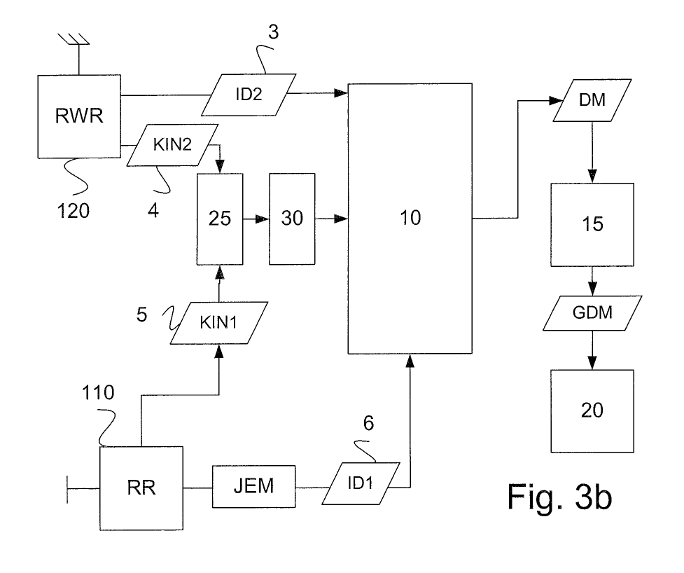

FIG. 3a schematically illustrates an alternative association architecture 300, according to a second embodiment of the invention. Units, identity data, kinematics data and processes are substantially identical as depicted with reference to FIG. 2. However, an alternative arrangement is provided as compared to FIG. 2. The first identity data entity ID1 and the second identity data entity ID2 are first subjected to the identity distance matrix generating process 35 so as to generate the identity distance matrix IDM2. Subsequently, the generated identity distance matrix IDM is subjected to the identity data gate 40 resulting in a gated identity matrix GIDM.

The first and second kinematics data KIN1 and KIN2 are directly supplied to the combined distance matrix generating process 10, wherein the distance matrix generating process 10 is adapted to generate a distance matrix DM comprising elements of combined data of both identity data achieved from the process 40, and kinematics data KIN1 and KIN2 provided by the radar unit 110 and the radar warning unit 120, respectively.

The generated distance matrix DM is then subjected to the general gate process 15. Subsequently the gated distance matrix DM is subjected to the association process 20.

FIG. 3b depicts a third embodiment of the present invention which has substantially the same association architecture as depicted with reference to FIG. 3a. However, in this embodiment the first and second kinematics data entities KIN1 and KIN2 are first subjected to the kinematics distance matrix generating process 25 followed by the kinematics distance gating process 30.

The first and second identity data entities ID1 and ID2 are provided to the distance matrix generating process 10 from the radar unit 110 and the radar warning unit 120, respectively. The distance matrix generating process 10 is arranged to generate a combined distance matrix DM depending on the generated kinematics data matrix GKINM and the first and second identity data entities ID1 and ID2.

The generated distance matrix DM is then subjected to the general gating process 15. The gating process 15 is adapted to generate a gated distance matrix GDM. Subsequently, the gated distance matrix GDM is subjected to the association process 20.

FIG. 4a schematically illustrates a generated kinematics distance matrix KINM according to an embodiment of the invention.

According to this embodiment, two sensors are used and only kinematics data is dealt with. This matrix structure is applicable to other sets of data, such as identity data or identity data combined with kinematics data. The first sensor 110 generates a first kinematics data entity KIN1 comprising information about the spatial positions of three different objects denoted first object 101, second object 102 and third object 103.

The second sensor 120 generates a second kinematics data entity KIN2 comprising information about spatial positions of four different objects denoted first object 201, second object 202, third object 203 and fourth object 204.

Alternatively or in addition, the first and second kinematics data entities KIN1 and KIN2 can comprise information, for example, speed, velocity, and/or acceleration/retardation information.

The sensors of the platform have different accuracies which are considered in computations according to the invention.

### EXAMPLE 1

### Calculation of dk11

Position coordinates in 3D of an object 101 are defined as P₁₀₁=P₁₀₁(x₁₀₁, y₁₀₁, z₁₀₁) and generated by the first sensor 110. The sensor is also arranged to determine confidence C₁₀₁ of the position coordinates P₁₀₁.

Position coordinates in 3D of an object 201 are defined as P₂₀₁=P₂₀₁(x₂₀₁, y₂₀₁, z₂₀₁) and generated by the second sensor 120. The sensor is also arranged to determine the confidence of the position coordinates P₂₀₁.

dk11=ƒ(C₁₀₁₋₂₀₁, P₁₀₁, P₂₀₁), wherein f is a function, and wherein C₁₀₁₋₁₀₂ is a factor of confidence generated depending on C₁₀₁ and C₂₀₁.

dk11 is considered to be χ² distributed, which is important in gating procedures according to an aspect of the invention.

Another definition of dk11 is
dk11=(P₁₀₁−P₂₀₁)^{T}(K₁₀₁+K₂₀₁)(P₁₀₁−P₂₀₁),

where K₁₀₁ and K₂₀₁ are covariance matrixes of P₁₀₁ and P₂₀₁, respectively.

The other elements of the matrix KINM are generated in a similar way. It should be noted that this example is for illustrative purposes only. More sophisticated models are used in real applications and are known in the art, but are not described in further detail herein.

Identity data generated by any of the sensors 110, 120 and/or 130 may be of various forms. Identity data is preferably represented by numerical values corresponding to unique identity parameters.

### EXAMPLE 2

### Determination of did11

Similarly to the embodiment described above in example 1, instead of position coordinates, identity data can be determined using the identity data matrix IDM which comprises elements did11-did34. This matrix is not shown.

The first and second sensors 110 and 120 are arranged to generate identity data units which are matched against identity data pre-stored in the database 170. A numerical value is generated depending on each matching procedure.

Similar to the procedure detailed in example 1, the element did11 is defined as a difference (“distance”) between the detected data corresponding to a first object relative to the first sensor 110 and detected data corresponding to a first object relative to the second sensor 120. did11 is thus a numerical value indicating a level of mutual resemblance between the objects 101 and 201, with a certain confidence. A low value may indicate that the two objects in fact are identical.

### EXAMPLE 3

### Elements of a Combined Distance Matrix DM

Elements cd11-cd34 (not shown) of a combined distance matrix DM are, according to a preferred embodiment, defined as:
cd11=dk11+did11

FIG. 4b schematically illustrates the matrix with reference to FIG. 4a, wherein the matrix has been subjected to the gating process 25. The gating process 25 is substantially a filtering process adapted to set element values dk11-dk34 to “void” if they are larger than a predetermined threshold value TH. This means that an element dk11-dk34 which is lower than the predetermined threshold value TH is considered to constitute a possible match of two objects detected by different sensors, i.e. the difference between detected data representing parameters of the two objects is small enough to contain the possibility that the two detected objects are in fact the same object.

In this example, the elements dk13, dk22, dk31, dk33 and dk34 are values greater than the threshold value TH, the result is that the gating process sets the elements dk13, dk22, dk31 dk33 and dk34 equal to “void”. It should be noted that, in general, the smaller the value TH is, the more elements are set to “void”. This implicitly allows a faster and easier matching procedure of detected objects. However, with a low preset threshold value tolerances decrease, meaning that erroneous matching may increase. The threshold value TH should be set to a desired value, for example, taking into account risk analysis of erroneous matching. The threshold value TH should be tuned in accordance with reported sensor accuracy.

FIG. 4c schematically illustrates an associated distance matrix ADM. The associated distance matrix ADM is the distance matrix DM after being subjected to the association process 20. The association process 20 is adapted to generate a final match of detected objects.

As shown in the matrix, ck14, ck21 and ck32 are the resulting association of objects detected by two different sensors 110 and 120. The first object 101 detected by the first sensor 110 and the fourth object 204 detected by the second sensor 120 are associated, meaning that they are considered to be the same object. Further, the second object 102 detected by the first sensor 110 and the first object 201 detected by the second sensor 120 are associated, meaning that they are considered to be the same object. Likewise, the third object 103 detected by the first sensor 110 and the second object 202 detected by the second sensor 120 are associated, meaning that they are considered to be the same object.

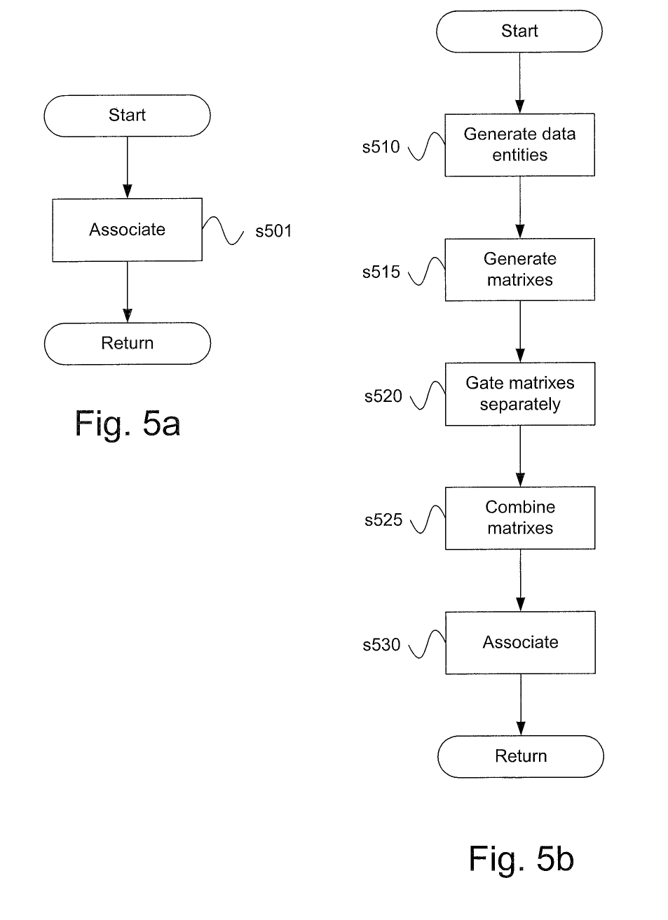

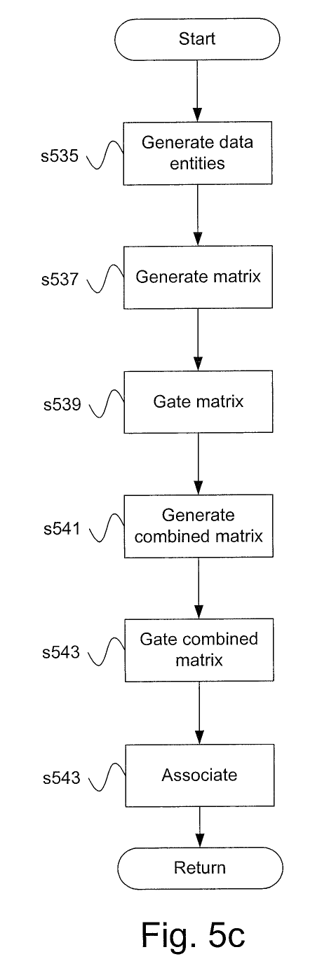

FIG. 5a schematically illustrates a flowchart depicting a method for improving association accuracy of data, for example kinematics data or identity data, generated by different sensors provided on a platform and being arranged to detect and/or register said data having various qualities, wherein said method comprises the step of:
generating a first data entity comprising a first information set and second information set about at least one object; and
generating a second data entity comprising a first information set and a second information set about at least one object;

wherein the method is characterized by
generating at least one distance matrix using the first information sets or the second information sets;
gating said at least one generated distance matrix; and
performing an association process depending upon the gated distance matrix.

Preferably the method comprises the step of:
generating a combined distance matrix based upon the gated distance matrix.

Preferably the method comprises the step of:
generating a first distance matrix comprising the first information sets and a second distance matrix comprising the second information sets.

Preferably the method comprises the step of:
performing an association process depending on the generated combined distance matrix or generated distance matrixes.

Preferably one of the first information set or the second information set comprises kinematics data about the at least one object.

Preferably one of the first information set or the second information set comprises identity data about the at least one object.

Preferably the method comprises the step of:
gating the generated distance matrixes separately.

Preferably the method comprises the step of:
generating the first data entity and the second data entity continuously for performing the association process in real time.

Preferably the method comprises the step of:
displaying and/or storing a result of the association process.

FIG. 5b schematically illustrates a flowchart depicting a method for improving association of data representing at least one object detected by different sensors provided on a platform in greater detail, according to an embodiment of the invention.

In a first method step s510 identity data entities ID1, ID2 and kinematics data entities KIN1, KIN2 are generated. After the method step s510 a next method step s515 is performed.

In method step s515 an identity data matrix IDM is generated depending upon said identity data entities ID1, ID2. Further, a kinematics distance matrix KINM is generated depending upon said kinematics data KIN1, KIN2 After the method step s515 a next method step s520 is performed.

In method step s520 the identity distance matrix IDM and the kinematics distance matrix KINM are gated separately by two different independent gates. After the method step s520 a next method step s525 is performed.

In method step s525 the two gated matrixes, referred to as GIDM and GKINM, are combined to one distance matrix DM. After the method step s525 a next method step s530 is performed.

In method step s530 the distance matrix DM is subjected to an association process resulting in a final match of the at least one object detected by the different sensors. After the method step s530 the method ends.

FIG. 5c schematically illustrates a flowchart depicting a method for improving association of data representing at least one object detected by different sensors provided on a platform in greater detail, according to an embodiment of the invention.

In a first method step s535 identity data entities ID1, ID2 and kinematics data entities KIN1, KIN2 are generated. After the method step s535 a next method step s537 is performed.

In method step s537 an identity distance matrix IDM is generated depending upon said identity data entities ID1, ID2. After the method step s537 a next method step s539 is performed.

In method step s539 the identity distance matrix IDM is gated by a unique gate. After the method step s539 a next method step s541 is performed.

In method step s541 kinematics data KIN1, KIN2 is provided to the gated identity data matrix, referred to as GIDM, resulting in a combined distance matrix DM. After the method step s541 a next method step s543 is performed.

In method step s541 the distance matrix DM is subjected to an association process resulting in a final match of the at least one object detected by the different sensors. After the method step s541 the method ends.

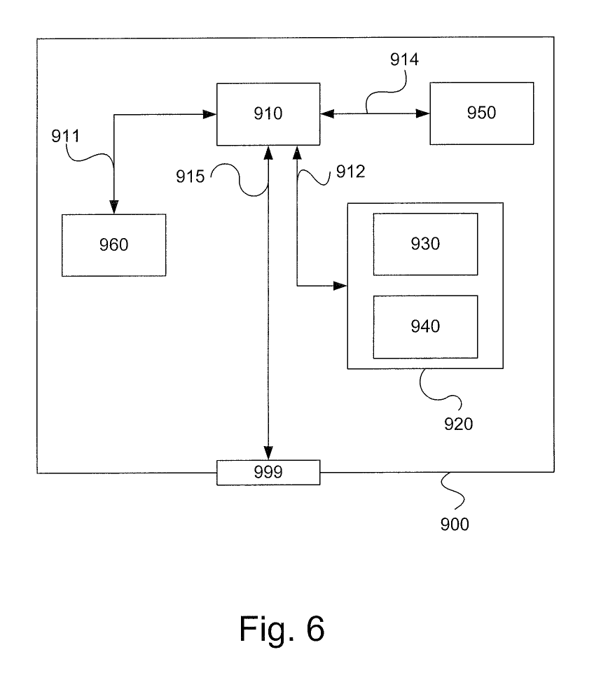

With reference to FIG. 6, a diagram of one embodiment of an apparatus 900 is shown. The above-mentioned computer 530 or a monitoring device (not shown) may include apparatus 900. Apparatus 900 comprises a non-volatile memory 920, a data processing device 910 and a read/write memory 950. Non-volatile memory 920 has a first memory portion 930 wherein a computer program, such as an operating system, is stored for controlling the function of apparatus 900. Further, apparatus 900 comprises a bus controller, a serial communication port, I/O-means, an A/D-converter, a time date entry and transmission unit, an event counter and an interrupt controller (not shown). Non-volatile memory 920 also has a second memory portion 940.

A computer program according to an aspect of the invention is provided, wherein the program comprises routines for carrying out processing of data, for example kinematics data or identity data, generated by different sensors provided on a platform and being arranged to detect and/or register said data having various quality. The program may be stored in an executable manner or in a compressed state in a separate memory 960 and/or in read/write memory 950.

Data processing device 910 may be, for example, a microprocessor.

When it is described that data processing device 910 performs a certain function it should be understood that data processing device 910 performs a certain part of the program which is stored in separate memory 960, or a certain part of the program which is stored in read/write memory 950.

Data processing device 910 may communicate with a data port 999 by means of a data bus 915. Non-volatile memory 920 is adapted for communication with data processing device 910 via a data bus 912. Separate memory 960 is adapted to communicate with data processing device 910 via a data bus 911. Read/write memory 950 is adapted to communicate with data processing device 910 via a data bus 914.

When data is received on data port 999 it is temporarily stored in second memory portion 940. When the received input data has been temporarily stored, data processing device 910 is set up to perform execution of code in a manner described above. According to one embodiment, data received on data port 999 comprises information such as KIN1, KIN2, ID1 and ID2. This information can be used by apparatus 900 for improving association accuracy of data according to the invention.

Parts of the methods described herein can be performed by apparatus 900 by means of data processing device 910 running the program stored in separate memory 960 or read/write memory 950. When apparatus 900 runs the program, parts of the methods described herein are executed.

An aspect of the invention relates to a computer programme comprising a programme code for performing the method steps depicted with reference to FIGS. 5a-c, when the computer programme is run on a computer.

An aspect of the invention relates to a computer programme product comprising a program code stored on computer-readable media for performing the method steps depicted with reference to FIGS. 5a-c, when the computer programme is run on the computer.

An aspect of the invention relates to a computer programme product directly storable in an internal memory of a computer, comprising a computer programme for performing the method steps depicted with reference to FIGS. 5a-c, when the computer programme is run on the computer.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. Method for increasing data association accuracy, comprising the steps of
generating a first data entity comprising a first information set and second information set about at least one object; and
generating a second data entity comprising a first information set and a second information set about at least one object,
further comprising the steps of
generating at least one distance matrix using the first information sets or the second information sets;
gating said at least one generated distance matrix; and
performing an association process depending upon the gated distance matrix.

2. Method according to claim 1, further comprising the step of
generating a combined distance matrix based upon the gated distance matrix.

3. Method according to claim 1 further comprising the step of
generating a first distance matrix comprising the first information sets and a second distance matrix comprising the second information sets.

4. Method according to claim 2, further comprising the step of
performing an association process depending on the generated combined distance matrix or generated distance matrixes.

5. Method according to claim 1 wherein one of the first information set or the second information set comprises kinematics data about the at least one object.

6. Method according to claim 1, wherein one of the first information set or the second information set comprises identity data about the at least one object.

7. Method according to claim 3, further comprising the step of
gating the generated distance matrixes separately.

8. Method according to claim 1, further comprising the step of
generating the first data entity and the second data entity continuously for performing the association process in real time.

9. Method according to claim 1, further comprising the step of
displaying and/or storing a result of the association process.

10. Arrangement, suitable for increasing data association accuracy, comprising
means for generating a first data entity comprising a first information set and a second information set about at least one object; and
means for generating a second data entity comprising a first information set and second information set about at least one object,
further comprising
means for generating at least one distance matrix depending upon the first information sets or the second information sets;
means for gating said at least one generated distance matrix, and
means for performing an association process depending upon the gated distance matrix.

11. Arrangement according to claim 10, further comprising means for generating a combined distance matrix based upon the at least one gated distance matrix.

12. Arrangement according to claim 10 further comprising
means for generating a first distance matrix comprising the first information sets; and
means for generating a second distance matrix comprising the second information sets.

13. Arrangement according to claim 11, further comprising
means for performing the association process depending upon the generated combined distance matrix or the generated distance matrixes.

14. Arrangement according to claim 10, wherein
one of the first information set or the second information set comprises kinematics data about the at least one object.

15. Arrangement according to claim 10, wherein
one of the first information set or the second information set comprises identity data about the at least one object.

16. Arrangement according to claim 12, further comprising
means for gating the generated distance matrixes separately.

17. Platform, such as an airplane, helicopter or unmanned craft, comprising an
arrangement suitable for increasing data association accuracy, comprising
means for generating a first data entity comprising a first information set and a second information set about at least one object; and
means for generating a second data entity comprising a first information set and second information set about at least one object,
further comprising
means for generating at least one distance matrix depending upon the first information sets or the second information sets;
means for gating said at least one generated distance matrix, and
means for performing an association process depending upon the gated distance matrix.

18. Computer programme comprising a programme code for performing the method steps of
generating a first data entity comprising a first information set and second information set about at least one object; and
generating a second data entity comprising a first information set and a second information set about at least one object, further comprising the steps of
generating at least one distance matrix using the first information sets or the second information sets;
gating said at least one generated distance matrix; and
performing an association process depending upon the gated distance matrix, when the computer programme is run on a computer.

19. Computer programme product comprising a program code stored on computer-readable media for performing the method steps of
generating a first data entity comprising a first information set and second information set about at least one object; and
generating a second data entity comprising a first information set and a second information set about at least one object,
further comprising the steps of
generating at least one distance matrix using the first information sets or the second information sets;
gating said at least one generated distance matrix; and
performing an association process depending upon the gated distance matrix, when the computer programme is run on the computer.

20. Computer programme product directly storable in an internal memory of a computer, comprising a computer programme for performing the method steps of
generating a first data entity comprising a first information set and second information set about at least one object; and
generating a second data entity comprising a first information set and a second information set about at least one object,
further comprising the steps of
generating at least one distance matrix using the first information sets or the second information sets;
gating said at least one generated distance matrix; and
performing an association process depending upon the gated distance matrix, when the computer programme is run on the computer.
